(19) United States
(12) Patent Application Publication
(10) Pub. No.: US 2011/0205590 A1
(43) Pub. Date: Aug. 25, 2011

(54) STORAGE DEVICE, SUBSTRATE, LIQUID CONTAINER, HOST DEVICE, AND SYSTEM

(75) Inventor: Yasuhiko Kosugi, Matsumoto-shi (JP)

(73) Assignee: SEIKO EPSON CORPORATION, Shinjuku-ku (JP)

(21) Appl. No.: 13/031,145

(22) Filed: Feb. 18, 2011

(30) Foreign Application Priority Data
Feb. 22, 2010 (JP) 2010-035899

(51) Int. Cl. G06F 3/12

(52) U.S. Cl. 358/1.15

(57) ABSTRACT

A storage device includes a storage section, a storage control section that controls access of the storage section, a control section that performs a process of communicating with a host device, a data terminal, a reset terminal, and a clock terminal. The control section outputs a control signal for setting, to a low potential level, a voltage level of the data terminal pulled up at an m-th (m is an integer where 1≦m≦n) clock cycle, which corresponds to ID information of the corresponding storage device, among first to n-th (n is an integer of 2 or more) clock cycles of a clock which is input to the clock terminal.

### BACKGROUND

1. Technical Field

The present invention relates to a storage device, a substrate, a liquid container, a host device, a system and the like.

2. Related Art

In printers used in which ink cartridges are mounted, in order to prevent a printing process from being executed in a state where the ink cartridges are not mounted, it is necessary to detect whether or not the ink cartridges are mounted.

In regards to this issue, for example, JP-A-2002-14870 discloses a method of detecting whether or not the ink cartridges are mounted by detecting whether or not they are electrically conducted through detection terminals provided in a printer and ink cartridges. However, in this method, there is a problem in that, for example, the number of terminals increases.

Further, for example, JP-A-2009-274438 discloses a method of using a terminal for detecting a remaining ink level in detecting whether or not the ink cartridges are mounted. However, in this method, there is a problem in that, for example, when the method of detecting the remaining ink level is changed to another method, it is difficult to decrease the number of terminals.

### SUMMARY

An advantage of some aspects of the invention is to provide a storage device, a substrate, a liquid container, a host device, and a system capable of efficiently detecting connection while suppressing an increase in the number of terminals.

According to a first aspect of the invention, a storage device includes: a storage section; a storage control section that controls access of the storage section; a control section that performs a process of communicating with a host device; a data terminal; a reset terminal; and a clock terminal. The control section outputs a control signal for setting, to a low potential level, a voltage level of the data terminal pulled up at an m-th (m is an integer where 1≦m≦n) clock cycle, which corresponds to ID information of the corresponding storage device, among first to n-th (n is an integer of 2 or more) clock cycles of a clock which is input to the clock terminal.

In the first aspect of the invention, at the m-th clock cycle corresponding to the ID information of the corresponding storage device, the pulled-up voltage level of the data terminal is set to the low potential level. Hence, by detecting the change in the voltage level of the data terminal, it is possible to detect whether or not each storage device is connected. In such a manner, the terminal for detecting presence or absence of each storage device is not necessary, and thus it is possible to reduce the number of terminals. Further, since it is possible to detect the presence or absence of one storage device for the time period of one clock cycle, it is possible to shorten detection time. As a result, it is possible to efficiently detect the connection of the storage device.

Further, in the first aspect of the invention, it is preferable that the storage device should include a control terminal. It is also preferable that the control section should output, through the control terminal, the control signal for setting the pulled-up voltage level of the data terminal to the low potential level.

In such a manner, it is possible to output the control signal through the control terminal. Hence, by outputting the control signal to the outside of the storage device, it is possible to set the pulled-up voltage level of the data terminal to the low potential level.

Further, according to the first aspect of the invention, it is preferable that the control section should include a mode determination portion that determines whether an operation mode is a normal communication mode or a connection detection mode and a response portion that outputs the control signal. It is also preferable that, when it is determined that the operation mode is the connection detection mode, the response portion should output the control signal for setting the pulled-up voltage level of the data terminal to the low potential level.

In such a manner, when it is determined that the operation mode is the connection detection mode, it is possible to output the control signal for setting the pulled-up voltage level of the data terminal to the low potential level. Hence, it is possible to perform the control process of detecting the connection separately from the normal communication mode. By performing the control process separately from the normal communication mode, it is possible to restrict the access to the storage section within the ID information. Thus, it is possible to prevent the storage data from unintentionally being damaged.

Further, in the first aspect of the invention, it is preferable that the mode determination portion should determine that the operation mode is the connection detection mode when a voltage level of the reset terminal is the low potential level and should determine that the operation mode is the normal communication mode when the voltage level of the reset terminal is a high potential level.

In such a manner, it is possible to determine the operation mode depending on the voltage level of the reset terminal. With such a configuration, it is possible to not use a particular signal for setting the operation mode, and thus it is possible to reduce the number of terminals.

Further, in the first aspect of the invention, it is preferable that, after power activation, the response portion should determine that a timing, at which a voltage level of the clock terminal changes from a first voltage level to a second voltage level, is a start timing of the first clock cycle. It is also preferable that, at the m-th clock cycle after the start timing, the response portion should output the control signal.

In such a manner, it is possible to determine the start timing of the first clock cycle, and thus it is possible to output the control signal at the timing appropriate for the clock cycle corresponding to the ID information.

Further, in the first aspect of the invention, it is preferable that, assuming that a length of each clock cycle of the clock which is input to the clock terminal is TC, after elapse of a time period longer than TC from a power activation timing, the response portion should determine that the timing, at which the voltage level of the clock terminal changes from the first voltage level to the second voltage level, is the start timing of the first clock cycle.

In such a manner, during the time period from the power activation timing to the start timing of the first clock cycle, it is determined that the mode determination portion is the connection detection mode, and then it is possible to secure the time for reading out the ID information from the storage section.

Further, in the first aspect of the invention, it is preferable that the response portion should include a counter and a consistent determination section that determines consistency between a count value of the counter and a value of the ID information which is read from the storage section. In addition, it is also preferable that, when the count value is consistent with the value of the ID information, the response portion should output the control signal.

In such a manner, it is possible to reliably output the control signal at the clock cycle corresponding to the ID information.

Further, in the first aspect of the invention, it is preferable that, after power activation, the response portion should determine that a timing, at which a voltage level of the clock terminal changes from a first voltage level to a second voltage level, is a start timing of the first clock cycle. In addition, it is also preferable that the counter should perform a process of counting the clock which is input to the clock terminal after the start timing.

In such a manner, since it is possible to appropriately count the clock cycles from the first clock cycle to the n-th clock cycle, it is possible to output the control signal at the appropriate clock cycle corresponding to the ID information.

Further, in the first aspect of the invention, it is preferable that the response portion should output the control signal to a plurality of clock cycles among the first to n-th clock cycles.

In such a manner, one storage device is able to output the control signal at each of the plurality of clock cycles.

Further, in the first aspect of the invention, it is preferable that the storage device should include a voltage setting circuit that sets the voltage level of the data terminal. In addition, it is also preferable that the voltage setting circuit should pull up the voltage level of the data terminal during a time period in which a voltage level of the reset terminal is the low potential level and should set the voltage level of the data terminal to the low potential level on the basis of the control signal.

In such a manner, the voltage level of the data terminal is pulled up during the time period in which the voltage level of the reset terminal is the low potential level, and thus it is possible to set the voltage level to the low potential level during the time period in which the control signal is output.

According to a second aspect of the invention, a substrate includes the above-mentioned storage device.

According to a third aspect of the invention, a liquid container includes the above-mentioned storage device.

According to the third aspect of the invention, it is possible to efficiently detect whether or not the storage device included in the liquid container is appropriately connected. Consequently, it is possible to efficiently detect whether or not the liquid container is appropriately mounted.

Further, in the third aspect of the invention, it is preferable that, when liquids having a plurality of colors are contained, the control signal should be output at a plurality of clock cycles, which corresponds to the plurality of colors, among the first to n-th clock cycles.

In such a manner, even when the liquid container contains liquids with the plural colors, it is possible to associate the plural colors with the plural clock cycles.

According to a fourth aspect of the invention, a system includes the above-mentioned storage device and a host device.

According to the fourth aspect of the invention, the host device is able to efficiently detect whether or not the storage device is appropriately connected. As a result, it is possible to improve reliability of the system.

According to a fifth aspect of the invention, a host device includes: first to k-th (k is an integer of 2 or more) host side terminals; a communication processing section that performs a process of communicating with first to n-th (n is an integer of 2 or more) storage devices through the first to k-th host side terminals; and a monitoring section. One of the first to k-th host side terminals is a host side data terminal. The monitoring section performs connection detection of the first to n-th storage devices by monitoring whether or not a pulled-up voltage level of the host side data terminal is set to a low potential level at each clock cycle of the first to n-th clock cycles of clocks supplied to the first to n-th storage devices.

According to the fifth aspect of the invention, at each clock cycle of the first to n-th clock cycles, by monitoring whether or not a pulled-up voltage level of the host side data terminal is set to a low potential level, it is possible to detect whether or not each storage device is connected.

Further, in the fifth aspect of the invention, it is preferable that the host device should include a power supply section that supplies power to the first to n-th storage devices. In addition, it is preferable that, when a power supply time period of a connection detection mode is set between a power supply time period of a normal communication mode and a subsequent power supply time period of the normal communication mode, assuming that a length of the power supply time period of the normal communication mode is TA and a length of the power supply time period of the connection detection mode is TB, the power supply section should supply power so that TA>TB.

In such a manner, it is possible to provide the time period of the connection detection mode in the short time period between the single time period of the normal communication mode and the subsequent time period of the normal communication mode. Hence, it is possible to detect the connection of the storage device without disturbing normal data communication. As a result, it is possible to improve reliability of the system.

Further, in the fifth aspect of the invention, it is preferable that, when a voltage level of the host side data terminal is pulled up to a high potential level after power activation, a process of detecting connection of the first to n-th storage devices should be performed by outputting the clocks. In addition, it is preferable that, when the voltage level of the host side data terminal is not pulled up to the high potential level after the power activation, the process of outputting the clocks should not be performed.

In such a manner, when none of storage devices are connected, it is possible to prevent the unnecessary clocks from being output.

Further, in the fifth aspect of the invention, it is preferable that the host device should include a display control section that performs control to display a result of the connection detection on a display section.

In such a manner, it is possible to display, in real time, whether or not the storage device is appropriately connected. As a result, by preventing errors from being caused when a user exchanges the liquid container, it is possible to improve operability.

Further, in the fifth aspect of the invention, it is preferable that, when a voltage level of the host side data terminal is not pulled up to a high potential level after power activation, a process of displaying notification that none of storage devices of the first to n-th storage devices are connected should be performed.

In such a manner, it is possible to display, in real time, the notification that none of storage devices are connected. As a result, in the state where none of the liquid containers are mounted, it is possible to prevent a user from erroneously performing an operation.

### BRIEF DESCRIPTION OF THE DRAWINGS

The invention will be described with reference to the accompanying drawings, wherein like numbers reference like elements.

FIG. 1 is a basic configuration example of a system.

FIG. 2 is a basic configuration example of a storage device.

FIG. 3 is a modified example of the storage device.

FIG. 4 is an example of a timing chart of the storage device.

FIGS. 5A to 5C are diagrams illustrating a configuration example of a mode determination portion.

FIG. 6 is a basic configuration example of a response portion.

FIG. 7 is an example of a correspondence relationship between ID information and clock cycles.

FIG. 8 is another example of the correspondence relationship between the ID information and the clock cycles.

FIG. 9 is a specific configuration example of the liquid container.

FIGS. 10A and 10B are specific configuration examples of a circuit board.

FIG. 11 is a basic configuration example of a host device.

FIG. 12 is a diagram illustrating a power supply time period of a normal communication mode and a connection detection mode.

### DESCRIPTION OF EXEMPLARY EMBODIMENTS

Hereinafter, preferred embodiments of the invention will be described in detail. The embodiments described below do not limit the invention, and all the configurations described in the embodiments are not necessarily required as means for resolution of the invention.

### 1. Basic Configuration Example of System

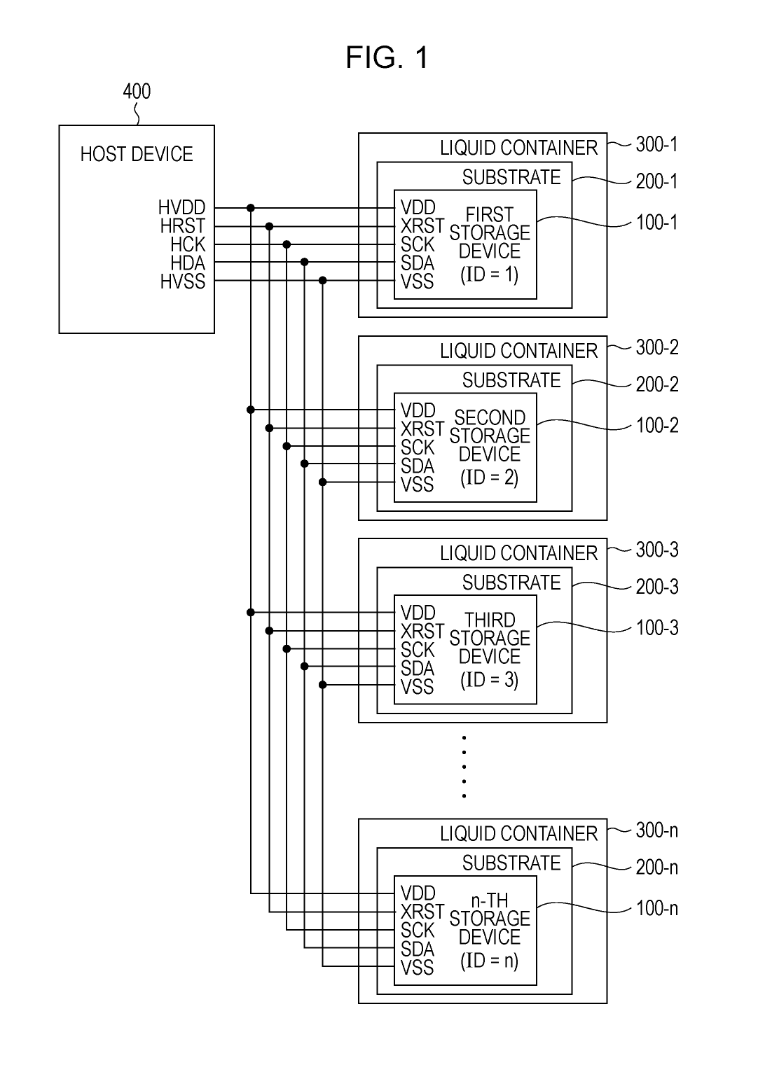

FIG. 1 shows a basic configuration example of the system according to the embodiment. In the basic configuration example of the system according to the embodiment, the system includes first storage device 100-1 to n-th (n is an integer of 2 or more) storage device 100-n, n substrates 200-1 to 200-n having the storage devices mounted thereon, n liquid containers 300-1 to 300-n having the substrates mounted thereon, and a host device 400. In addition, the system according to the embodiment is not limited to the configuration of FIG. 1, and may be modified into various forms. For example, a part of the components may be omitted, or other components may be added.

Each of the first to n-th storage devices 100-1 to 100-n include a reset terminal XRST, a clock terminal SCK, a data terminal SDA, a first power supply terminal VSS, and a second power supply terminal VDD. As described later, each of the n storage devices 100-1 to 100-n includes a storage section (for example, a non-volatile memory, or the like). The respective storage sections store ID (Identification) information (for example, ID=1, ID=2, ID=3, and the like) for identifying n liquid containers (such as ink cartridges) 300-1 to 300-n. Different IDs are assigned thereto in accordance with each respective type such as the liquid color contained in the liquid containers.

Each storage device has a normal communication mode (a normal operation mode) and a connection detection mode as operation modes. The normal communication mode is a mode for transmitting the data of the storage section to the host device or updating data of the storage section into data received from the host device. The connection detection mode is defined as an operation mode of the storage device used when detecting whether or not each storage device is connected to the host device.

In the connection detection mode, each storage device outputs the control signal for setting the pulled-up voltage level of the data terminal SDA to a low potential level (an L level) in accordance with each clock cycle of the clocks supplied from a host device 400. The control signal is output at the m-th (m is an integer where 1≦m≦n) clock cycle corresponding to the ID information of each storage device.

The host device 400 includes the first to k-th (k is an integer of 2 or more) host side terminals. Specifically, for example, the host device 400 includes a host side reset terminal HRST, a host side clock terminal HCK, a host side data terminal HDA, a first host side power supply terminal HVSS, and a second host side power supply terminal HVDD. The host device 400 is, for example, a printer main body, and as described later, monitors whether or not the pulled-up voltage level of the host side data terminal HDA is set to the low potential level (the L level) by the storage devices 100-1 to 100-n.

When the storage device 100 is connected, the pulled-up voltage level of the host side data terminal HDA changes to the L level at the clock cycle corresponding to the storage device. In contrast, when the storage device 100 is not connected, the voltage level of the host side data terminal HDA is not changed, and is held at the pulled-up state, that is, the high potential level (the H level). Accordingly, by monitoring whether or not the voltage level of the host side data terminal HDA is set to the L level, it is possible to determine whether or not each storage device is connected, that is, whether or not each liquid container 300 is mounted.

As described above, in the system according to the embodiment, each storage device 100 outputs the control signal for setting the pulled-up voltage level of the data terminal SDA to the L level in response to each clock cycle of the clocks supplied from the host device 400. The host device 400 monitors whether or not the pulled-up voltage level of the host side data terminal HDA is set to the L level through each storage device 100. In such a manner, the terminal for detecting presence or absence of each storage device 100 (the liquid container 300) becomes unnecessary, and thus it is possible to reduce the number of terminals. Further, since it is possible to detect whether or not each storage device is connected at each clock cycle, it is possible to shorten the detection time. Furthermore, the control signal from each storage device is output at the m-th clock cycle corresponding to the ID information of each storage device. Hence, the host device 400 is able to identify which storage devices (liquid containers) of the n storage devices (liquid containers) are not mounted.

### 2. Storage Device

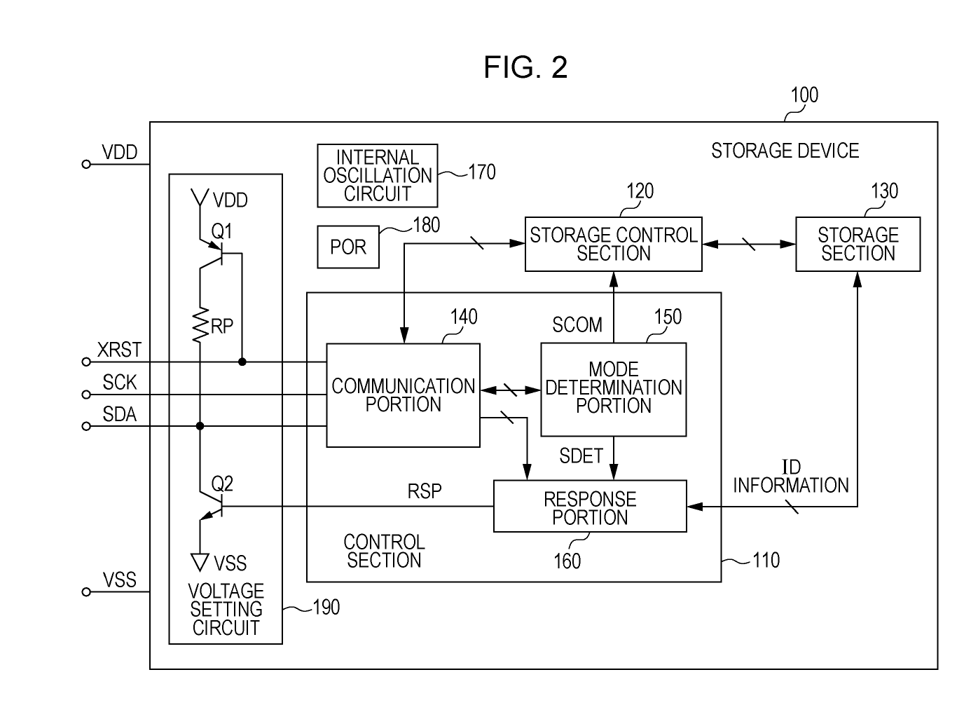

FIG. 2 shows a basic configuration example of the storage device 100 according to the embodiment. The storage device 100 according to the embodiment includes a control section 110, a storage control section 120, a storage section 130, a voltage setting circuit 190, a data terminal SDA, a reset terminal XRST, and a clock terminal SCK. In addition, the storage device 100 according to the embodiment is not limited to the configuration of FIG. 2, and may be modified into various forms. For example, a part of the components may be omitted, or other components may be added.

The storage section 130 stores the ID information input at the time of manufacture, the manufacture information, and the information input from the host device 400. For example, in the case of the ink cartridge, the storage section 130 stores the manufacture date information as manufacture information, ink color information, and the like, and stores the information on the remaining ink level as information input from the host device 400. The storage section 130 is formed of a non-volatile memory such as an FERAM (a ferroelectric memory) or a flash memory.

In addition, in the configuration, it is not always necessary to store the ID information for identifying the storage device 100 in the storage section 130 such as a non-volatile memory. For example, it is possible to store the ID information by using a fuse element, or it is possible to output the ID information by using a logic circuit.

The storage control section 120 controls access of the storage section 130 in the normal communication mode (the normal operation mode).

The control section 110 includes a communication portion 140, a mode determination portion 150, and a response portion 160. The communication portion 140 communicates with the host device 400.

The mode determination portion 150 determines whether the operation mode is the normal communication mode (the normal operation mode) or the connection detection mode. When it is determined that the operation mode is the normal communication mode, a mode setting signal SCOM for the storage control section 120 is set to the active level. When it is determined that the operation mode is the connection detection mode, the mode setting signal SDET for the response portion 160 is set to the active level.

Specifically, when the voltage level of the reset terminal XRST is the L level, the mode determination portion 150 determines that the operation mode is the connection detection mode. In contrast, when the voltage level of the reset terminal XRST is the H level, it is determined that the operation mode is the normal communication mode.

The normal communication mode (the normal operation mode) is an operation mode for performing data communication for interchanging data on the remaining ink level and the like between the host device 400 and the storage device 100.

The connection detection mode is an operation mode for detecting whether or not the storage device 100 is connected.

The control section 110 outputs the control signal RSP for setting the pulled-up voltage level of the data terminal SDA to the L level, at the m-th (m is an integer where 1≦m≦n) clock cycle corresponding to the ID information of the corresponding storage device 100 among the first to n-th (n is an integer of 2 or more) clock cycles of the clock which is input to the clock terminal SCK. Specifically, for example, the storage device with ID=1 outputs the control signal RSP for setting the pulled-up voltage level of the data terminal SDA to the L level at the first clock cycle corresponding to the ID information, and the storage device with ID=2 outputs the control signal RSP at the second clock cycle corresponding to the ID information.

When it is determined that the operation mode is the connection detection mode, the response portion 160 outputs, to the voltage setting circuit 190, the control signal RSP for setting the pulled-up voltage level of the data terminal SDA to the L level. Specifically, when the mode setting signal SDET supplied from the mode determination portion 150 is at the active level, the response portion 160 reads out the ID information stored in the storage section 130, and outputs the control signal RSP to the voltage setting circuit 190 at the clock cycle corresponding to the ID information. More specifically, for example, the voltage level of the control signal RSP is set to the H level.

An internal oscillation circuit 170 generates the internal clock of the storage device 100, and supplies the clock to the control section 110, the storage control section 120, and the storage section 130.

A power-on reset (POR) circuit 180 performs a power-on reset process on the basis of the second power source voltage VDD. That is, the storage device 100 is in the reset state until the power is applied, and when the power is applied, the reset of the storage device 100 is released. Specifically, the power-on reset circuit 180 sets the power-on reset signal POROUT to the H level (the high potential level, that is, a second voltage level in a wider sense), when power is applied to the host device 400 and the difference between second power source voltage VDD and the first power source voltage VSS is equal to or more than a threshold voltage (a predetermined voltage).

The voltage setting circuit 190 includes two transistors Q1 and Q2 and a pull-up resistor RP. When the voltage level of the reset terminal XRST is the L level (a voltage level representing the reset state in a wider sense) and the control signal RSP supplied from the response portion 160 is the L level (an inactive level in a wider sense), the transistor Q1 is in an ON state, and the transistor Q2 is in an OFF state. Then, the voltage level of the data terminal SDA is pulled up to the H level.

In contrast, when the voltage level of the reset terminal XRST is the L level and the control signal RSP is the H level (an active level in a wider sense), all the transistors Q1 and Q2 are in the ON state. In this case, by appropriately setting the current drive abilities of the transistors Q1 and Q2 and the resistance of the pull-up resistor RP, it is possible to set the voltage level of the data terminal SDA to the L level. As described above, the voltage setting circuit 190 pulls up the voltage level of the data terminal SDA during the time period in which the voltage level of the reset terminal XRST is the L level, and sets the voltage level of the data terminal SDA to the L level on the basis of the control signal RSP supplied from the response portion 160.

In addition, in the voltage setting circuit 190 shown in FIG. 2, the bipolar transistors are used as the transistors Q1 and Q2, but other transistors may be used. For example, the P-type MOS transistor may be used as the transistor Q1, and the N-type MOS transistor may be used as the transistor Q2.

As described above, in the storage device according to the embodiment, at the m-th clock cycle corresponding to the ID information of the corresponding storage device, the control signal RSP for setting the pulled-up voltage level of the data terminal SDA to the L level is output. The host device (the printer main body) is able to detect the connection of the respective storage devices by monitoring whether or not the voltage level of the data terminal SDA is set to the L level at each clock cycle. With such a configuration, the terminal for detecting presence or absence of each storage device (each liquid container) becomes unnecessary, and thus it is possible to reduce the number of terminals.

Furthermore, in the case of the connection detection mode, it suffices to read out only the ID information from the storage section. Hence, by forbidding (masking) access to other data, it is possible to prevent storage content from being unintentionally damaged. Further, since it is possible to detect presence or absence of one storage device (liquid container) during the time period of one clock cycle, it is possible to shorten the detection time. Furthermore, the control signal supplied from each storage device is output at the m-th clock cycle corresponding to the ID information of each storage device. Hence, the host device is able to identify which storage devices (liquid container) are not mounted.

On the other hand, in the method of detecting presence or absence of the liquid container by using the normal communication mode (the normal operation mode), it is necessary to wait until a time-out error occurs in communication. For this reason, it takes time before the detection, and thus there is a concern about occurrence of errors during the communication. As a result, regards of a liquid container being mounted, there is a possibility that it is determined that the liquid container is not mounted.

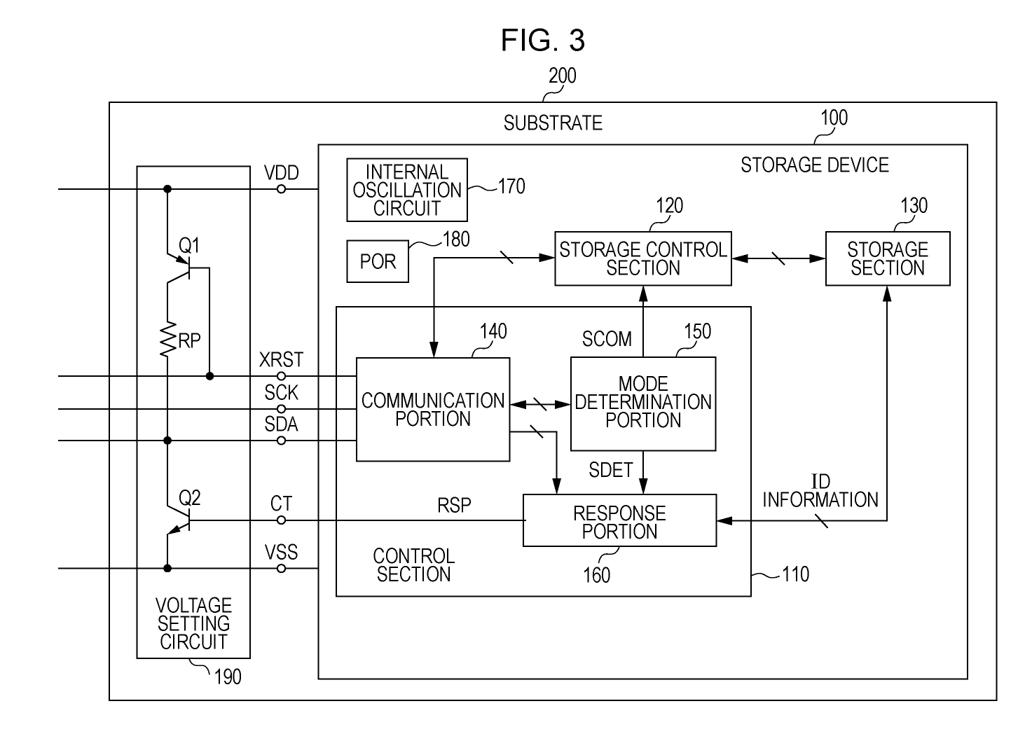

FIG. 3 shows a modified example of the above-mentioned storage device 100 according to the embodiment. In the modified example shown in FIG. 3, the storage device 100 includes a control terminal CT. The control section 110 outputs, through the control terminal CT, the control signal RSP, which is for setting the pulled-up voltage level of the data terminal SDA to the L level, to the voltage setting circuit 190. The voltage setting circuit 190 is provided in a substrate 200, and similarly to the configuration example of FIG. 2, includes the two transistors Q1 and Q2 and the pull-up resistor RP.

The operation of the voltage setting circuit 190 is the same as that described in FIG. 2. That is, when the voltage level of the reset terminal XRST is the L level and the control signal RSP supplied from the response portion 160 is the L level, the transistor Q1 is in an ON state, and the transistor Q2 is in an OFF state. Then, the voltage level of the data terminal SDA is pulled up to the H level. In contrast, when the voltage level of the reset terminal XRST is the L level and the control signal RSP is the H level, all the transistors Q1 and Q2 are in the ON state. In this case, by appropriately setting the current drive abilities of the transistors Q1 and Q2 and the resistance of the pull-up resistor RP, the voltage level of the data terminal SDA is set to the L level.

In addition, similarly to the voltage setting circuit 190 of FIG. 2, transistors other than the bipolar transistors may be used as the transistors Q1 and Q2. For example, the P-type MOS transistor may be used as the transistor Q1, and the N-type MOS transistor may be used as the transistor Q2.

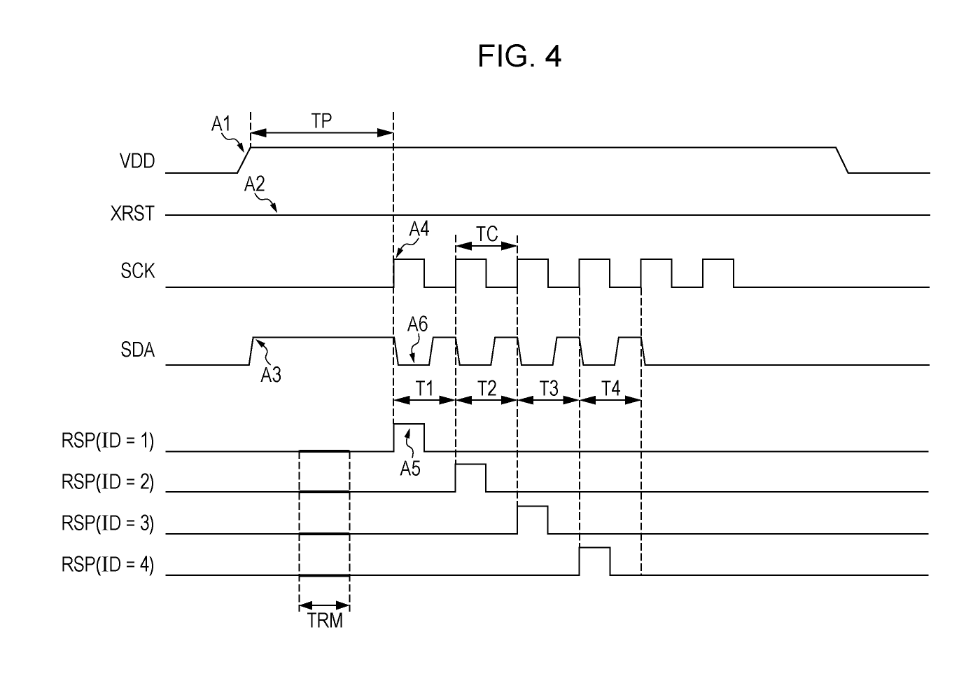

FIG. 4 is an example of a timing chart of the storage device 100. FIG. 4 shows the second power source voltage VDD and the reset terminal XRST, the voltage levels of the clock terminal SCK and the data terminal SDA, and the control signals RSP. The control signals RSP correspond to the cases where the ID information is ID=1 to 4.

Referring to FIG. 4, the operation of the storage device 100 will be described. First, the second power source voltage VDD rises up (A1 in FIG. 4), and the VDD reaches the predetermined voltage. Then, the power-on reset (POR) circuit 180 sets the power-on reset signal POROUT (not shown in the drawing) to the H level (the high potential level, that is, the second voltage level in a wider sense), thereby releasing the power-on reset.

When the voltage level of the reset terminal XRST is the voltage level (the L level in FIG. 4) representing the reset state (A2 in FIG. 4), the mode determination portion 150 determines that the operation mode is the connection detection mode.

Then, the voltage setting circuit 190 pulls up the voltage level of the data terminal SDA to the H level (A3 in FIG. 4). As described above, the reason is that the voltage level of the reset terminal XRST is the L level and the voltage level of the control signal RSP is also the L level.

Next, the voltage level of the clock terminal SCK changes from the L level (the first voltage level in a wider sense) to the H level (the second voltage level in a wider sense) (A4 in FIG. 4). This timing is set as the start timing of the first clock cycle T1. That is, after the power activation, the response portion 160 determines that the timing, at which the voltage level of the clock terminal SCK changes from the first voltage level (the L level) to the second voltage level (the H level), is the start timing of the first clock cycle T1.

The control section 110 outputs the control signal RSP for setting the pulled-up voltage level of the data terminal SDA to the L level, at the m-th (m is an integer where 1≦m≦n) clock cycle corresponding to the ID information of the corresponding storage device 100 among the first to n-th (n is an integer of 2 or more) clock cycles of the clock which is input to the clock terminal SCK.

Specifically, for example, as shown in FIG. 4, the storage device, of which the ID information is 1, sets the control signal RSP to the H level at the first clock cycle T1 (A5 in FIG. 4). Then, the storage device, of which the ID information is 2, sets the control signal RSP to the H level at the second clock cycle T2. Likewise, at the third and fourth clock cycles T3 and T4, the control signal RSP is set to the H level. In addition, after it is determined that the operation mode is the connection detection mode, the ID information of each storage device is read out from the storage section 130 of each storage device 100 in the ID-information readout period TRM before the start timing of the first clock cycle T1.

As described above, the voltage setting circuit 190 sets the voltage level of the data terminal SDA to the L level when the control signal RSP is the H level. Accordingly, for example, at the first clock cycle T1, during the time period in which the control signal RSP is the H level, the voltage level of the data terminal SDA is set to the L level (A6 in FIG. 4). Likewise, at the second to fourth clock cycles T2 to T4, during the time period in which the control signal RSP is the H level, the voltage level of the data terminal SDA is set to the L level.

In addition, in FIG. 4, the control signal RSP is set to the H level during the first-half time period of each clock cycle, but may be set to the H level during the latter half time period of each clock cycle. Alternatively, the control signal RSP may be set to the H level during the middle time period of each clock cycle.

Assuming that the length from the power activation timing (A1 in FIG. 4) to the start timing of the first clock cycle T1 (A4 in FIG. 4) is TP and the length of each clock cycle of the clock input to the clock terminal SCK is TC, TP>TC. That is, after the elapse of a time period longer than TC from a power activation timing, the response portion 160 determines that the timing, at which the voltage level of the clock terminal SCK changes from the first voltage level (the L level) to the second voltage level (the H level), is the start timing.

With such a configuration, after power activation, the power-on reset circuit 180 releases the power-on reset, and then each circuit of the storage device 100 starts operations thereof. Then, the mode determination portion 150 determines that the operation mode is the connection detection mode. Subsequently, it is possible to secure the time for reading out the ID information from the storage section 130.

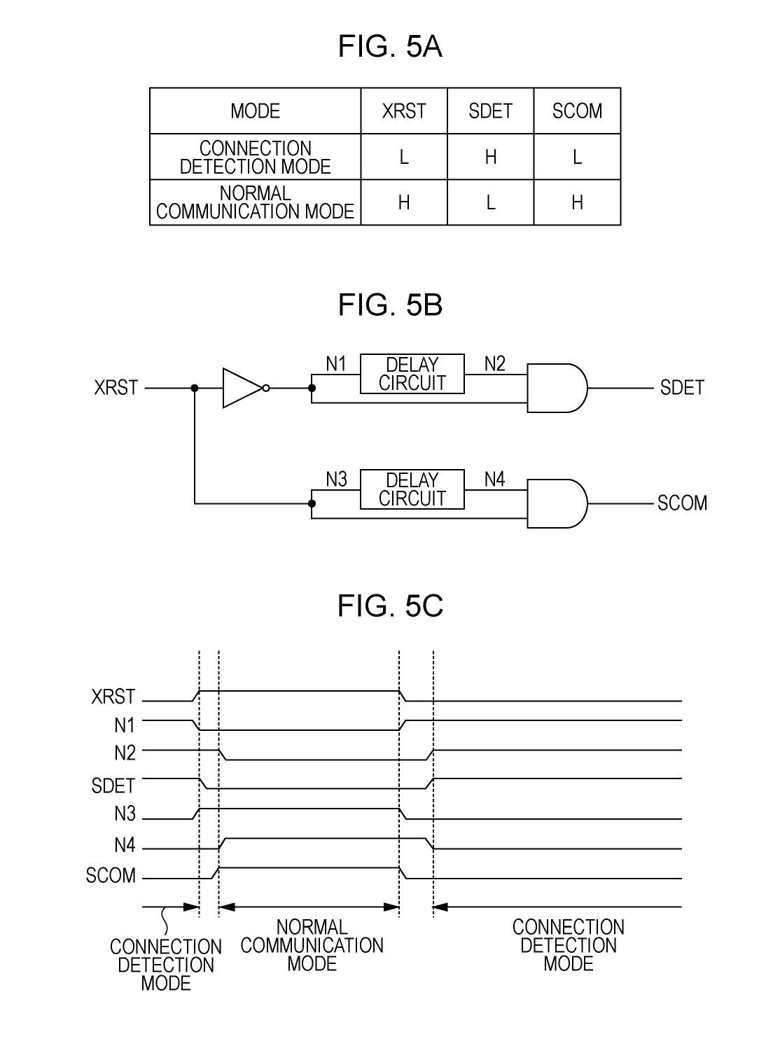

FIGS. 5A to 5C are diagrams illustrating a configuration example of the mode determination portion 150. As shown in FIG. 5A, the mode determination portion 150 determines that the operation mode is the connection detection mode during the time period in which the voltage level of the reset terminal XRST is the voltage level (the L level) representing the reset state. Then, the mode determination portion 150 sets the mode setting signal SDET for the response portion 160 to the active level (the H level).

On the other hand, during the time period in which the voltage level of the reset terminal XRST is the voltage level (the H level) representing the reset release state, the mode determination portion 150 determines that the operation mode is the normal communication mode. Then, the mode determination portion 150 sets the mode setting signal SCOM for the response portion 160 to the active level (the H level).

FIG. 5B shows the configuration example of the mode determination portion 150. In the configuration example, the mode determination portion 150 includes a delay circuit, an AND logic circuit, and an inverter. By providing two delay circuits, it is possible to prevent the mode setting signal SDET and the mode setting signal SCOM from simultaneously changing to the active level. The delay circuit can be implemented by cascading even numbers of inverters.

FIG. 5C is a timing chart illustrating the operation of the configuration example of the mode determination portion 150. During the time period in which the voltage level of the reset terminal XRST is the voltage level (the L level) representing the reset state, the mode setting signal SDET is set to the active level (the H level). On the other hand, during the time period in which the voltage level of the reset terminal XRST is the voltage level (the H level) representing the reset release state, the mode setting signal SCOM is set to the active level (the H level).

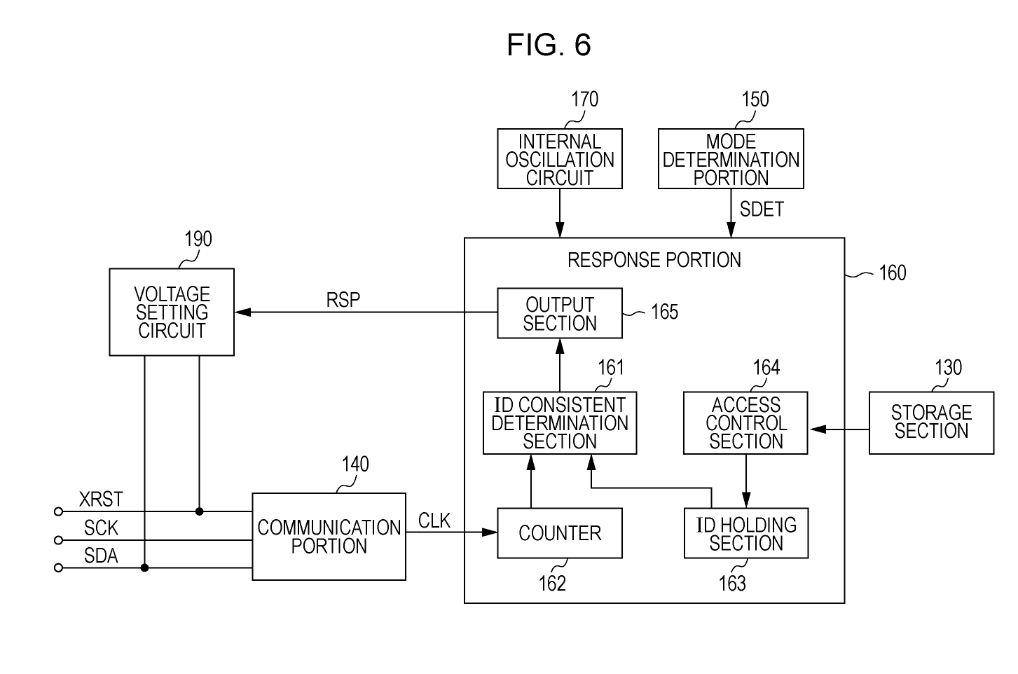

FIG. 6 shows a basic configuration example of the response portion 160. The response portion 160 includes an ID consistent determination section 161, a counter 162, an ID holding section 163, an access control section 164, and an output section 165.

The ID consistent determination section 161 (the consistent determination section in a wider sense) determines that the count value of the counter 162 is consistent with the value of the ID information which is read out from the storage section 130. The counter 162 performs a process of counting the clock CLK which is input to the clock terminal SCK after the start timing of the first clock cycle T1. The ID holding section 163 holds the value of the ID information which is read out from the storage section 130, and outputs the value to the ID consistent determination section 161. The access control section 164 accesses the storage section 130 and reads out the value of the stored ID information. The output section 165 outputs the control signal RSP to the voltage setting circuit 190 on the basis of the determination result of the ID consistent determination section 161.

When the count value is consistent with the value of the ID information, the response portion 160 outputs the control signal RSP. Specifically, for example, as shown in the above-mentioned timing chart of FIG. 4, when the mode determination portion 150 determines that the operation mode is the connection detection mode (A2 in FIG. 4), the mode determination portion 150 sets the mode setting signal SDET to the active level. Then, the access control section 164 reads out the value of the ID information from the storage section 130 during the ID-information readout period TRM, and the ID holding section 163 holds the value of the ID information. Next, the counter 162 starts the process of counting the clock CLK after the start timing (A4 in FIG. 4) of the first clock cycle T1.

Then, the ID consistent determination section 161 determines whether or not the count value of the counter 162 is consistent with the value of the ID information. When there is consistency between the values, the control signal RSP is output from the output section 165 to the voltage setting circuit 190. For example, as shown in FIG. 4, at the first clock cycle T1, the count value is 1, and thus the control signal RSP is output from the storage device with ID=1. Likewise, at the second clock cycle T2, the count value is 2, and thus the control signal RSP is output from the storage device with ID=2. In such a manner, at the clock cycle corresponding to the value of the ID information of each storage device, the control signal RSP is output.

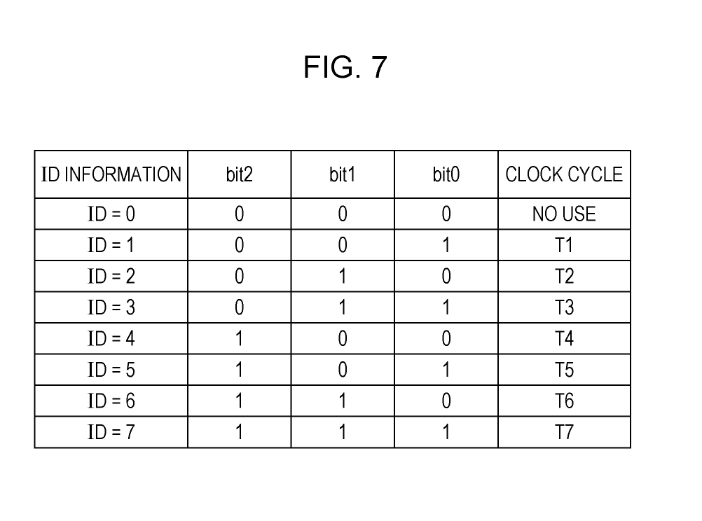

FIG. 7 shows an example of the correspondence relationship between the ID information and the clock cycles. In FIG. 7, the values of the ID information is represented by 3 bits, and ID=0 to ID=7 can be used. However, as shown in FIG. 7, ID=0 may not be used. The ID=1 corresponds to the first clock cycle T1, and the ID=2 corresponds to the second clock cycle T2. In the same manner as described above, ID=3 to 7 respectively correspond to the third to seventh clock cycles T3 to T7. In addition, it is not always necessary to use the ID=7 as the ID information. For example, when the number of ink cartridges (liquid containers) used in practice is 4, it is preferable to use ID=1 to 4 as the ID information. Specifically, for example, it is possible to associate four colors (black, cyan, magenta, and yellow) of the ink cartridges with ID=1 to 4, respectively.

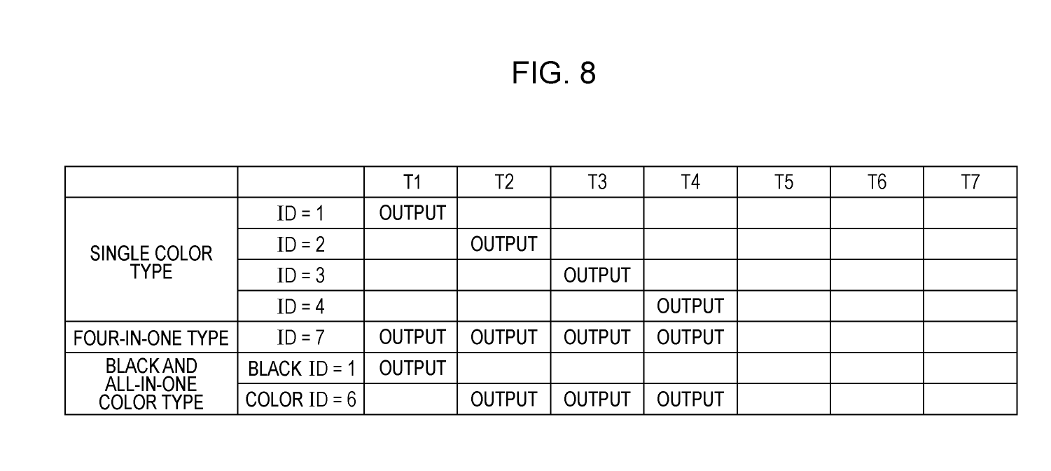

FIG. 8 shows another example of the correspondence relationship between the ID information and the clock cycles. FIG. 8 shows not only single-color-type liquid containers, in which each single liquid container (ink cartridge) contains each single color liquid (ink or the like), but also all-in-one liquid container in which a single liquid container contains liquids with plural colors.

For example, when the single color type is used, as described above, ID=1 to 4 are associated with the liquid containers for the respective colors (black, cyan, magenta, and yellow), and the control signals RSP are output at the clock cycles T1 to T4. Further, when the four-in-one type is used, the ID information is set so that ID=7, it is possible to output the control signals RSP at the clock cycles T1 to T4. Further, when the single black color type and the all-in-one color type are used in combination, by setting the ID information of the single black color type to ID=1, it is possible to output the control signal RSP at the clock cycle T1, and by setting the ID information of the all-in-one color type to ID=6, it is possible to output the control signals RSP at the clock cycles T2 to T4.

As described above, in the storage device 100 according to the embodiment, the response portion 160 is able to output the control signals RSP at plural clock cycles among the first to n-th clock cycles T1 to Tn. Further, in the liquid container 300 according to the embodiment, when the liquid container 300 contains liquids with plural colors, it is possible to output the control signals RSP at plural clock cycles, corresponding to the plural colors, among the first to n-th clock cycles T1 to Tn. With such a configuration, it is possible to associate the first to n-th clock cycles with n-color inks, respectively. Hence, no matter whether the ink cartridge is the single color type or the all-in-one type, it is possible to make the ink cartridge compatible without changing the firmware of the host device.

### 3. Substrate and Liquid Container

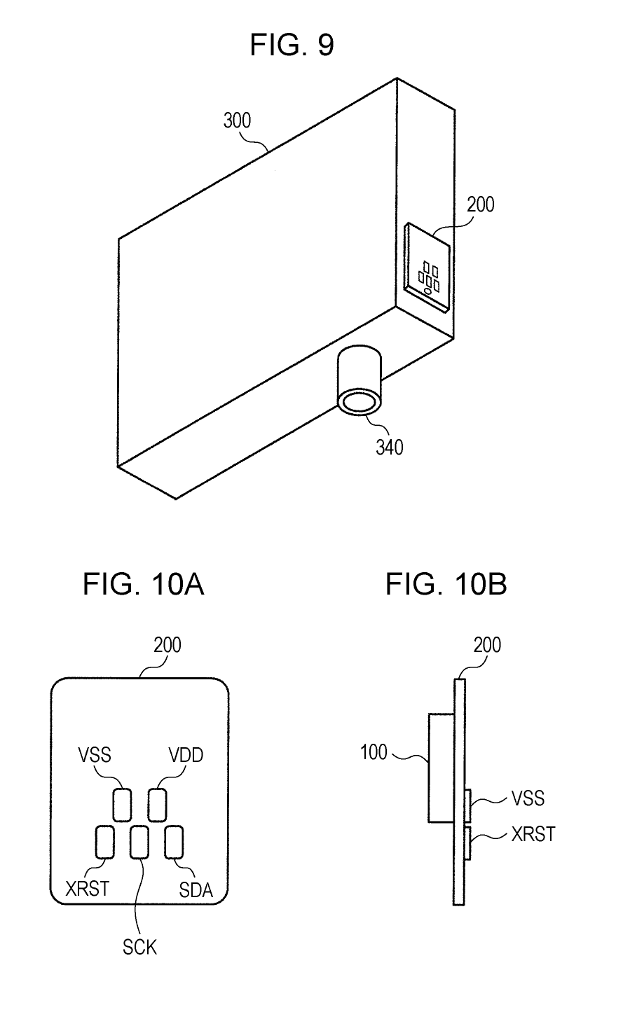

Next, a specific configuration example of the liquid container 300 equipped with the above-mentioned storage device 100 according to the embodiment will be described with reference to FIG. 9. Hereinafter, description will be given of an exemplary case where the host device 400 is an ink jet printer, the liquid container 300 is an ink cartridge, and a substrate 200 is a circuit board formed on the ink cartridge. Here, in the embodiment, the host device, the liquid container, and the substrate may be a different apparatus, a different container, and a different substrate. For example, the host device may be a reader/writer of the memory card, and the substrate may be a circuit board formed on the memory card.

In the ink cartridge 300 (the liquid container in a wider sense) shown in FIG. 9, an ink chamber, which is not shown in the drawing, for containing ink is formed. Further, in the ink cartridge 300, an ink supply port 340, which communicates with the ink chamber, is provided. The ink supply port 340 is for supplying the ink to the print head unit when the ink cartridge 300 is mounted in the printer.

The ink cartridge 300 includes the circuit board 200 (the substrate in a wider sense). The circuit board 200 is provided with the storage device 100 according to the embodiment, and stores the data or transmits and receives the data to and from the host device 400. The circuit board 200 is implemented by, for example, the print substrate, and is formed on the surface of the ink cartridge 300. The circuit board 200 is provided with a terminal such as the second power supply terminal VDD. In addition, when the ink cartridge 300 is mounted on the printer, by making the terminal come into contact with (electrically connect with) the terminal of the printer side, the power is applied or the data is interchanged.

FIGS. 10A and 10B show a specific configuration example of the circuit board 200 equipped with the storage device 100 according to the embodiment. As shown in FIG. 10A, a terminal group having plural terminals is provided on the surface (the surface which is connected to the printer) of the circuit board 200. The terminal group includes the first power supply terminal VSS, the second power supply terminal VDD, the reset terminal XRST, the clock terminal SCK, and the data terminal SDA. Each terminal is realized by the metal terminal formed in, for example, a rectangular shape (a substantially rectangular shape). In addition, each terminal is connected to the storage device 100 through a through hole or a wire pattern layer, not shown in the drawing, provided in the circuit board 200.

As shown in FIG. 10B, the storage device 100 according to the embodiment is provided on the rear surface (the surface opposite to the surface which is connected to the printer) of the circuit board 200. The storage device 100 can be realized by, for example, a semiconductor storage device having a ferroelectric memory. The storage device 100 stores various data relating to the ink or the ink cartridge 300. For example, the data on an amount of ink consumed and the ID information for identifying the ink cartridge 300 is stored. The data on the amount of ink consumed is data which represents, regarding the ink contained in the ink cartridge 300, the total sum of the amount of the ink consumed in accordance with the execution of printing and the like. The data on the amount of ink consumed may be information representing the amount of ink within the ink cartridge 300 and may be information representing the rate of the amount of ink consumed.

### 4. Host Device

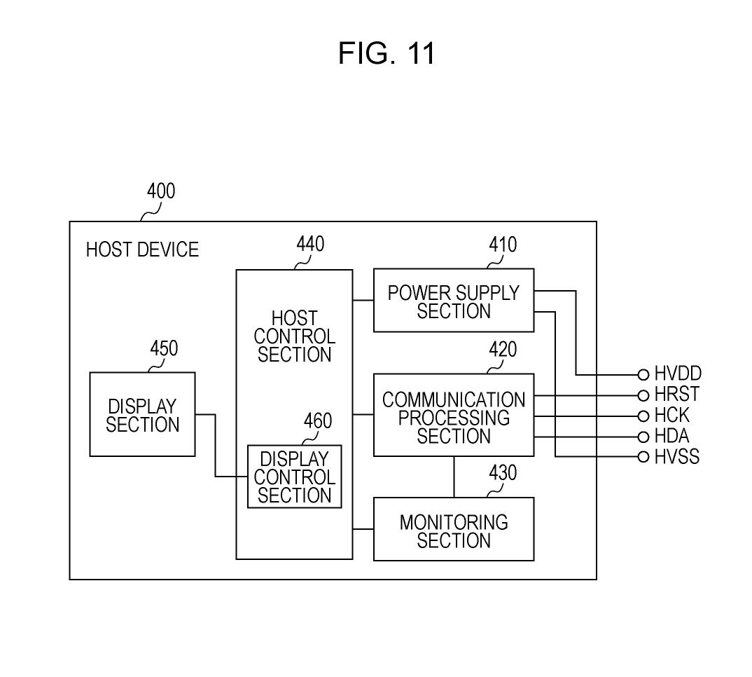

FIG. 11 shows a basic configuration example of the host device 400 according to the embodiment. The host device 400 is, for example, a printer main body, and includes a power supply section 410, a communication processing section 420, a monitoring section 430, a host control section 440, a display section 450, and a display control section 460. Furthermore, the host device 400 includes first to k-th (k is an integer of 2 or more) host side terminals. Specifically, the host device 400 includes, for example, a host side reset terminal HRST, a host side clock terminal HCK, a host side data terminal HDA, a first host side power supply terminal HVSS, and a second host side power supply terminal HVDD.

The power supply section 410 supplies power to the first to n-th storage devices 100-1 to 100-n. The communication processing section 420 performs a process of communicating with the first to n-th storage devices 100-1 to 100-n through the first to k-th host side terminals such as the host side reset terminal HRST, the host side clock terminal HCK, and the host side data terminal HDA.

The monitoring section 430 monitors whether or not the pulled-up voltage level of the host side data terminal HDA is set to the L level at each clock cycle of the first to n-th clock cycles T1 to Tn of the clocks supplied to the first to n-th storage devices 100-1 to 100-n.

The host control section 440 performs respective processes of controlling the power supply section 410, the communication processing section 420, the monitoring section 430 and the display section 450.

The display section 450 is, for example, an LCD (a liquid crystal display) or the like, and displays an operation screen of the host device 400 (the printer), an operation state, an error message, and the like. In the connection detection mode, the display section 450 displays the connection detection result on the basis of the monitoring result of the monitoring section 430.

The display control section 460 controls the display of the connection detection result on the display section 450. The display control section 460 can be realized by the heretofore known display controller or the like.

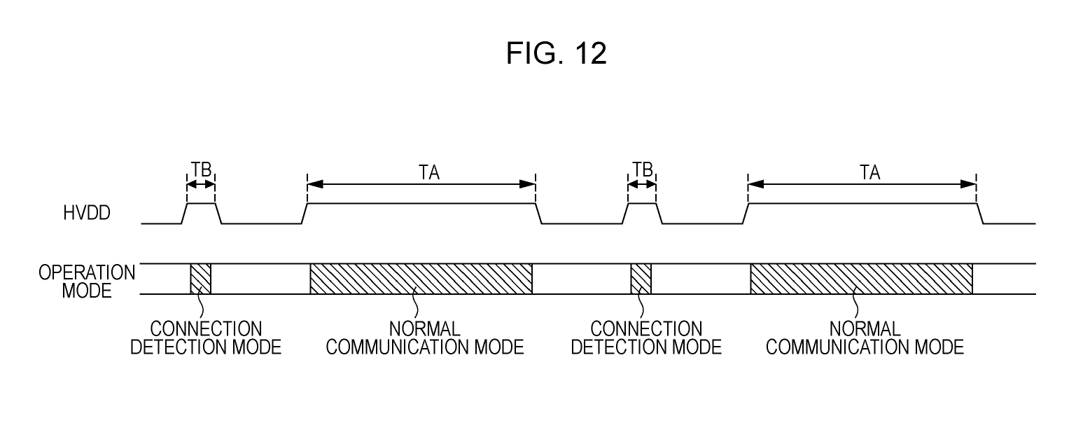

FIG. 12 is a diagram illustrating the power supply time period of the normal communication mode and the connection detection mode. Assuming that a length of the power supply time period of the normal communication mode is TA and a length of the power supply time period of the connection detection mode is TB, the power supply section 410 supplies power so that TA>TB. Further, the power supply time period of the connection detection mode may be set between the power supply time period of the normal communication mode and the subsequent power supply time period of the normal communication mode. In addition, although not shown in the drawing, the power supply time period of the connection detection mode may be successively set multiple times.

With such a configuration, it is possible to provide the time period of the connection detection mode in a short period between the single time period of the normal communication mode and the subsequent time period of the normal communication mode. Therefore, it is possible to detect connection of the ink cartridges without disturbing the normal data communication. As a result, it is possible to improve the reliability of the printer system.

Moreover, it is possible to detect the connection of the ink cartridge in a short period of time. Hence, it is possible to display presence or absence of the ink cartridge on the display section 450 in real time. As a result, by preventing errors from being caused when a user exchanges the ink cartridge, it is possible to improve operability.

As a method of a comparative example of the embodiment, it is conceivable that there is a method of detecting the time-out error of communication in the normal communication mode (the normal operation mode). However, in this method, it is necessary to wait until the time-out error of communication occurs. Hence, there is a problem in that the connection detection time increases. Thus, there is a concern about occurrence of errors during the communication. As a result, in the case of the occurrence of errors, even though the liquid container is mounted, there is a possibility that it is determined that the liquid container is not mounted.

In the embodiment, by providing the connection detection mode different from the normal communication mode, as shown in FIG. 4, it is possible to complete the connection detection corresponding to n cycles of the clock in the connection detection mode. In such a manner, as shown in FIG. 12, although the connection detection mode is provided separately from the normal communication mode, it is possible to make the length TB of the power supply time period of the connection detection mode be sufficiently smaller than the length TA of the power supply time period of the normal communication mode. With such a configuration, by setting the time period of the short-time connection detection mode between the single time period of the normal communication mode and the subsequent time period of the normal communication mode, it is possible to perform the connection detection. As a result, it is not necessary to perform the connection detection in the normal communication mode, and by providing the connection detection mode, it is possible to prevent the band of the normal communication mode from being restricted. Further, since it is possible to shorten the time necessary for the connection detection, it is possible to display the detection result in real time and reduce the number of errors at the time of the detection.

Further, in the storage device and the host device according to the embodiment, when the voltage level of the host side data terminal HDA is not pulled up to the H level after power activation, the host device 400 is able to determine that none of the storage devices (liquid containers) are connected (not mounted). This is because, when none of the storage devices 100 are connected, the voltage setting circuit 190 for pulling up the voltage level of the data terminal SDA is not connected.

When determining that none of the storage devices 100 are connected, the host device 400 is able to not perform the process of outputting the clocks. Specifically, when the voltage level of the host side data terminal HDA is pulled up to the H level after the power activation, by outputting the clocks, the process of detecting the connection of the first to n-th storage devices is performed. In contrast, when the voltage level of the host side data terminal HDA is not pulled up to the H level after the power activation, the process of outputting the clocks is not performed, and a process of displaying the notification that none of the first to n-th storage devices are connected is performed.

This notification display is performed, for example, in a way of displaying the notification on the display section 450 (the liquid crystal display or the like) through the control of the display control section 460. Alternatively, the notification is performed in a manner of lighting an LED (a light-emitting diode) or the like or in a manner of issuing the notification to a personal computer (PC) which is connected to the host device 400.

With such a configuration, when none of the storage devices are connected, it is possible to immediately stop power supply without outputting unnecessary clocks. Furthermore, it is possible to display, in real time, the notification that none of the storage devices are connected. As a result, it is possible to reduce trouble caused by an erroneous operation. For example, it is possible to prevent the printing process from being erroneously executed in a state where the ink cartridges are not mounted.

Although the invention has been described in detail with respect to the examples thereof, it should be understood by those skilled in the art that the invention may be modified into various forms without departing from the technical scope of the invention. Accordingly, it should be understood that the scope of the invention includes the modified examples. For example, in the description or the drawings, the terms (such as the L level and the H level), which are described at least once together with the broadly-defined or synonymous different terms (such as the first voltage level and the second voltage level), may be replaced with the different corresponding terms even when existing at any place in the description or the drawings. Further, the configurations and the operations of the storage device, the substrate, the liquid container, the host device, and the system is not limited to the embodiments mentioned above, and may be modified into various forms.

The entire disclosure of Japanese Patent Application No. 2010-035899, filed on Feb. 22, 2010 is expressly incorporated herein by reference.

What is claimed is:

1. A storage device comprising:
a storage section;
a storage control section that controls access of the storage section;
a control section that performs a process of communicating with a host device;
a data terminal;
a reset terminal; and
a clock terminal,
wherein the control section outputs a control signal for setting, to a low potential level, a voltage level of the data terminal pulled up at an m-th (m is an integer where 1≦m≦n) clock cycle, which corresponds to ID information of the corresponding storage device, among first to n-th (n is an integer of 2 or more) clock cycles of a clock which is input to the clock terminal.

2. The storage device according to claim 1,
further comprising a control terminal,
wherein the control section outputs, through the control terminal, the control signal for setting the pulled-up voltage level of the data terminal to the low potential level.

3. The storage device according to claim 1,
wherein the control section includes
a mode determination portion that determines whether an operation mode is a normal communication mode or a connection detection mode, and
a response portion that outputs the control signal, and
wherein when it is determined that the operation mode is the connection detection mode, the response portion outputs the control signal for setting the pulled-up voltage level of the data terminal to the low potential level.

4. The storage device according to claim 3,
wherein the mode determination portion
determines that the operation mode is the connection detection mode when a voltage level of the reset terminal is the low potential level, and
determines that the operation mode is the normal communication mode when the voltage level of the reset terminal is a high potential level.

5. The storage device according to claim 3,
wherein after power activation, the response portion determines that a timing, at which a voltage level of the clock terminal changes from a first voltage level to a second voltage level, is a start timing of the first clock cycle, and
wherein at the m-th clock cycle after the start timing, the response portion outputs the control signal.

6. The storage device according to claim 5,
wherein assuming that a length of each clock cycle of the clock which is input to the clock terminal is TC, after elapse of a time period longer than TC from a power activation timing, the response portion determines that the timing, at which the voltage level of the clock terminal changes from the first voltage level to the second voltage level, is the start timing of the first clock cycle.

7. The storage device according to claim 3,
wherein the response portion includes
a counter, and
a consistent determination section that determines consistency between a count value of the counter and a value of the ID information which is read from the storage section, and
wherein when the count value is consistent with the value of the ID information, the response portion outputs the control signal.

8. The storage device according to claim 7,
wherein after power activation, the response portion determines that a timing, at which a voltage level of the clock terminal changes from a first voltage level to a second voltage level, is a start timing of the first clock cycle, and
wherein the counter performs a process of counting the clock which is input to the clock terminal after the start timing.

9. The storage device according to claim 3,
wherein the response portion outputs the control signal to a plurality of clock cycles among the first to n-th clock cycles.

10. The storage device according to claim 1,
further comprising a voltage setting circuit that sets the voltage level of the data terminal,
wherein the voltage setting circuit pulls up the voltage level of the data terminal during a time period in which a voltage level of the reset terminal is the low potential level, and sets the voltage level of the data terminal to the low potential level on the basis of the control signal.

11. A substrate comprising the storage device according to claim 1.

12. A substrate comprising the storage device according to claim 2.

13. A liquid container comprising the storage device according to claim 1.

14. The liquid container according to claim 13,
wherein when liquids having a plurality of colors are contained, the control signal is output at a plurality of clock cycles, which corresponds to the plurality of colors, among the first to n-th clock cycles.

15. A system comprising:
the storage device according to claim 1; and
a host device.

16. A host device comprising:
first to k-th (k is an integer of 2 or more) host side terminals;
a communication processing section that performs a process of communicating with first to n-th (n is an integer of 2 or more) storage devices through the first to k-th host side terminals; and
a monitoring section,
wherein one of the first to k-th host side terminals is a host side data terminal, and
wherein the monitoring section performs connection detection of the first to n-th storage devices by monitoring whether or not a pulled-up voltage level of the host side data terminal is set to a low potential level at each clock cycle of first to n-th clock cycles of clocks supplied to the first to n-th storage devices.

17. The host device according to claim 16,
further comprising a power supply section that supplies power to the first to n-th storage devices,
wherein when a power supply time period of a connection detection mode is set between a power supply time period of a normal communication mode and a subsequent power supply time period of the normal communication mode, assuming that a length of the power supply time period of the normal communication mode is TA and a length of the power supply time period of the connection detection mode is TB, the power supply section supplies power so that TA>TB.

18. The host device according to claim 16,
wherein when a voltage level of the host side data terminal is pulled up to a high potential level after power activation, a process of detecting connection of the first to n-th storage devices is performed by outputting the clocks, and
wherein when the voltage level of the host side data terminal is not pulled up to the high potential level after the power activation, the process of outputting the clocks is not performed.

19. The host device according to claim 16,
further comprising a display control section that performs control to display a result of the connection detection on a display section.

20. The host device according to claim 16,
wherein when a voltage level of the host side data terminal is not pulled up to a high potential level after power activation, a process of displaying notification that none of storage devices of the first to n-th storage devices are connected is performed.
